(19) United States
(12) Patent Application Publication
(10) Pub. No.: US 2013/0272457 A1
(43) Pub. Date: Oct. 17, 2013

(54) GLOBAL NAVIGATION SATELLITES SYSTEM (GNSS) RECORDING SYSTEM

(71) Applicant: AVERNA TECHNOLOGIES INC, Montreal (CA)

(72) Inventors: Iurie ILIE, Dollard-des-Ormeaux (CA); Brendan WOLFE, Pincourt (CA); Stephane HAMEL, Longueuil (CA); Serge MALO, Montreal (CA)

(73) Assignee: Averna Technologies Inc, Montreal (CA)

(21) Appl. No.: 13/860,842

(22) Filed: Apr. 11, 2013

Related U.S. Application Data
(60) Provisional application No. 61/623,787, filed on Apr. 13, 2012.

(51) Int. Cl. H04L 1/00

(52) U.S. Cl. CPC H04L 1/0036
USPC 375/340

(57) ABSTRACT

The present disclosure provides methods for improving processing of GNSS signals. More particularly, the method reduces a bit resolution of a digital signal, by processing, based on a maximum threshold value and on a s-bit resolution value, the digital signal received with an n-bit resolution to generate requantized digital signal with the s-bit resolution. The method further determines an optimal gain of a Global Navigation Satellites Systems Radio Frequency (RF) signal recorder, by determining a range of values of a gain of the RF signal recorder corresponding to a selected range of values of a total noise of the RF signal recorder and RF signal receiver. The method also automatically detects disconnection of a RF signal recorder from a Global Navigation Satellites Systems (GGSN) Radio Frequency (RF) signal receiver, and synchronizes multiple RF recording systems.

### TECHNICAL FIELD

The present disclosure relates to the field of recording of Global Navigation Satellites System (GNSS) signals; and more particularly to several improvements to the recording of GNSS signals.

### BACKGROUND

GNSS is used to determine one or more of position, velocity, and time of a GNSS receiver. GNSS includes GPS of the United States, the GLONASS system of Russia, the Galileo system of European Union and Compass, the Chinese satellites navigation system. A GNSS signal is a specific type of Radio Frequency (RF) signal generated by an emitting satellite and received by GNSS receivers. GNSS receivers are used in multiple applications, including localization and navigation (e.g. in vehicles or mobile phones), surveying and mapping, etc. The GNSS receiver generally processes the RF analog GNSS signal received by means of an active antenna.

However, the power of the RF analog GNSS signal received is very weak and generally is under the noise level. This particularity of the GNSS signal adds multiple difficulties to the signal recording and playback (e.g. GNSS signal is difficult to detect on the spectrum view). For example, in certain conditions, the GNSS recorder may not operate properly: i.e. the antenna may be disconnected (or not powered) and consequently the GNSS recorder may only be receiving a noise signal. In another example, the GNSS recorder may be operating with a gain that is not appropriate considering the noise figure of the GNSS recorder's setup A user of the GNSS recorder who is not a specialist in RF/GNSS signals is generally not capable of detecting these issues, and even less solve them. As a result, the recorder and playback system cannot reproduce the original authentic signal from the GNSS antenna output.

The GNSS recorder is used in conjunction with a storage database to record the digital GNSS signal for later use. The stored digital GNSS signals are generally encoded using 16 bits, which generates a large amount of stored data; although in certain conditions, a resolution lower than 16 bits may be sufficient to adequately represent the received RF GNSS signal. Also, in certain cases, it may be necessary to synchronize multiple GNSS recorders located at different geographic locations.

There is therefore a need for improving various aspects of the processing and recording of RF GNSS signals.

### SUMMARY

According to a first aspect, the present disclosure provides a method for reducing the bit resolution of a digital signal. For doing so, the method receives, at a receiver, digital signals representative of analog signals, wherein the received digital signals are encoded with a n-bit resolution. The method selects a re-quantizing resolution, wherein the re-quantizing resolution is an s-bit resolution with s lower than n. The method calculates a Root Mean Square (RMS) value on a sample of the received digital signals. The method selects, for the s-bit resolution, a value representing a ratio of a maximal threshold to the RMS value. The method calculates the maximum threshold as a product of the RMS value by the selected value of the ratio. And the method processes, based on the maximum threshold value and on the s-bit resolution value, the digital signals received with a n-bit resolution to generate re-quantized digital signals with a s-bit resolution.

According to a second aspect, the present disclosure provides a method for dynamically adapting the bit resolution of a digital signal recording. For doing so, the method receives, at a receiver, a sample of digital signals corresponding to one of an I sample or a Q sample representative of analog signals, wherein the sample of digital signals are encoded with a 16-bit resolution. The method processes the sample of digital signals, to calculate an RMS value of the sample of digital signals, a maximal value in time domain of the sample of digital signals, and a maximal value in frequency domain of the sample of digital signals. The method determines that a pre-defined condition is met, wherein the pre-defined condition consists in a combination of at least one of: the RMS value is above a first pre-defined threshold, the maximum value in time domain is above a second pre-defined threshold, and the maximum value in frequency domain is above a third pre-defined threshold. And, if the pre-defined condition is not met, the method processes the sample of digital signals encoded with a 16-bit resolution, to generate a sample of digital signals encoded with a lower resolution.

According to a third aspect, the present disclosure provides a method for determining an optimal gain of a RF signal recorder. For doing so, the method calculates a range of values of a total gain of a RF signal recorder, as a product of gain values of sub-components of the RF signal recorder adapted to record a signal received from a Radio Frequency (RF) source system, wherein the gain values are fixed, except for the gain value of one sub-component which varies in a pre-determined range. The method calculates a range of values of a total noise of the RF signal recorder and RF signal source, as a function of fixed gain values and fixed noise values of sub-components of the RF signal source, and as a function of the gain values and fixed noise values of the sub-components of the RF signal recorder. The method calculates a range of values of the total noise of the RF signal recorder and RF signal source, as a function of the total gain of the RF signal recorder. The method stores in memory a converged noise figure value of the total noise of the RF signal recorder and RF signal source. The method selects a range of values of the total noise of the RF signal recorder and RF signal source representing a pre-defined maximum degradation of the converged noise figure value. And the method determines a range of values of the total gain of the RF signal recorder, corresponding to the range of values of the total noise of the RF signal recorder and RF signal source representing the pre-defined maximum degradation of the converged noised figure value.

According to a fourth aspect, the present disclosure provides a method for automatically detecting the disconnection of a RF signal source. For doing so, the method receives a signal at a Radio Frequency (RF) source system. The method transmits the received signal from the RF signal source to a RF signal recorder. The method measures, at the RF signal recorder, a signal power of the signal. The method calculates, at the RF signal recorder, a noise floor as a function of the measured signal power of the signal and of a recording bandwidth of the signal. The method calculates, at the RF signal recorder, a difference between the noise floor and an estimated noise floor, wherein the estimated noise floor is an estimation of the value of the noise floor when the RF signal recorder is disconnected from the RF source. And the method detects, at the RF signal recorder, that the RF signal recorder is disconnected from the RF signal source, when the difference is lower than a pre-defined detection threshold.

According to a fifth aspect, the present disclosure provides a method for synchronizing multiple GNSS recording systems. For doing so, the method receives, at a RF signal recorder, a configuration request from a synchronization control entity. The method sends an acknowledgement from the RF signal recorder to the synchronization control entity. The method receives, at the RF signal recorder, a recording request from the synchronization control entity. And the method starts a recording of a GNSS signal by the RF signal recorder synchronized on a Global Positioning System (GPS) one Pulse Per Second (1PPS) pulse selected from: a next GPS 1PPS pulse after reception of the recording request, or a next GPS 1PPS pulse after a selected Coordinated Universal Time (UTC) time.

The foregoing and other features of the present will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a GNSS recording system, according to a non-restrictive illustrative embodiment;

FIG. 2 illustrates an impact of bit resolution on signal quality for GNSS digital signals;

FIG. 3 illustrates a quantization algorithm according to a non-restrictive illustrative embodiment;

FIG. 4 illustrates a format for storing re-quantized data in a data storage system, according to a non-restrictive illustrative embodiment;

FIG. 5 illustrates a GNSS receiver system represented as a cascaded system of active/passive elements, according to a non-restrictive illustrative embodiment;

FIG. 6 illustrates a graph representing a total noise figure versus a gain of a RF signal recorder, according to a non-restrictive illustrative embodiment;

FIG. 7 illustrates values of noise floors for a GNSS receiver system with a connected antenna and a disconnected antenna; and

FIG. 8 illustrates a synchronization of multiple GNSS recording systems, according to a non-restrictive illustrative embodiment.

### DETAILED DESCRIPTION

The present disclosure relates to the field of recording of Global Navigation Satellites System (GNSS) signals; and more particularly to several improvements of the RF GNSS signal processing and recording.

### Terminology

Global Navigation Satellites System (GNSS): a satellite system that is used to pinpoint a geographic location of a GNSS receiver anywhere in the world. Multiple satellites transmit coded signals at precise intervals. The GNSS receiver converts received GNSS signals and embedded information into position, velocity, and time estimates. The Global Positioning System (GPS) is one among several implementations of a GNSS system. A GNSS signal is a particular type of Radio Frequency (RF) signal.

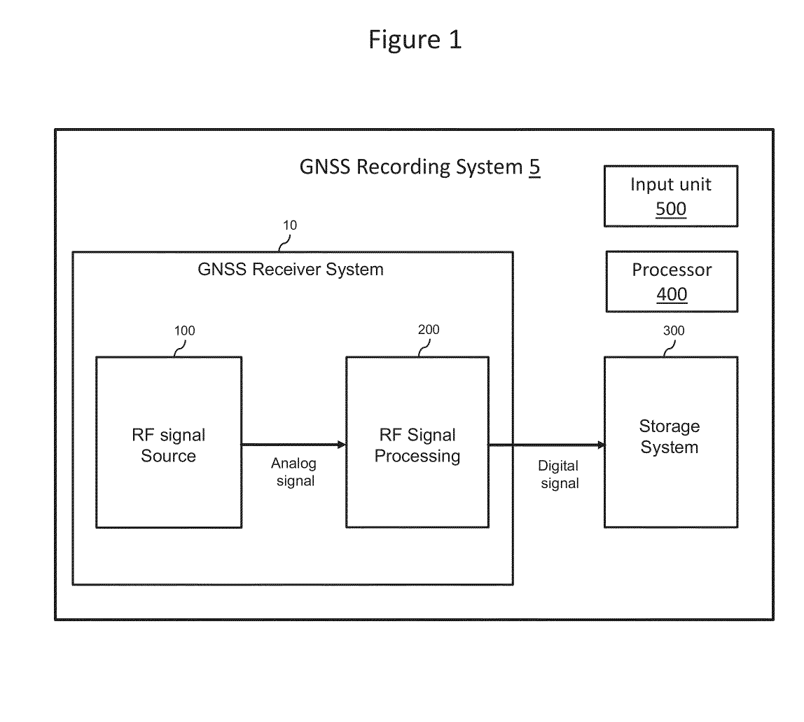

FIG. 1 illustrates a system 10 for recording GNSS signals. The GNSS recording system 5 comprises an RF signal receiver 100, for receiving an RF analog GNSS signal. The RF signal receiver 100 includes an antenna (not represented in FIG. 1) for receiving the GNSS signal. The GNSS recording system 5 also comprises a RF signal processing unit 200. The RF signal processing unit 200 process the received RF analog GNSS signal, and generates a corresponding digital GNSS signal. The digital GNSS signal is recorded by the RF signal processing unit 200 in a storage system 300 (e.g. a hard drive), which may be a standalone entity as represented in FIG. 1, or may be integrated with the GNSS receiver system 10 to form the GNSS recording system 5.

In the following embodiments of the present disclosure, several improvements of the GNSS recording system 5, will be introduced, discussed and illustrated.

### Automatic Detection of a Disconnection of a Signal Recorder

In an embodiment of the present disclosure, an automatic detection of a disconnection of the RF signal processing unit 200 from the RF signal source 100 is provided.

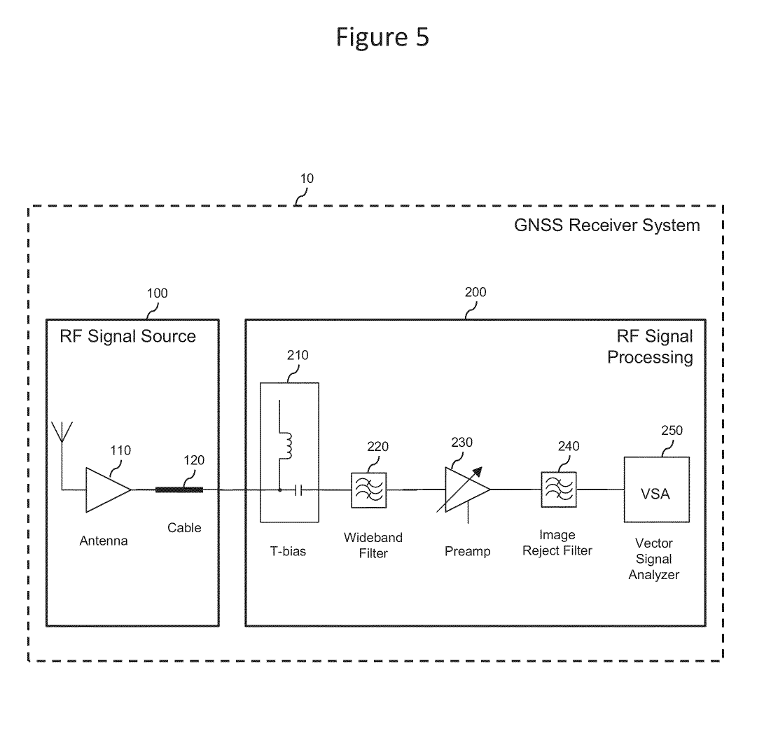

Reference is now concurrently made to FIGS. 1 and 5. GNSS signal recording is often used in the context of mobile applications, for instance when the GNSS recording system 5 is installed inside a car. In this case, the GNSS recording system 5 is subject to vibrations. And sometimes, this can lead to a loss of connection between the RF signal processing unit 200 and the RF signal source 100. For example, the cable 120 connecting the antenna 110 to the RF signal processing unit 200 may be disconnected. In the general case, a user with no specific background in the RF/GNSS field cannot detect the loss of connection while using the GNSS recording system 5.

Following is an algorithm to detect such a disconnection. The algorithm monitors as noise floor of the GNSS receiver system 10, and compares it to an estimated value (which is calculated based on the configuration of the GNSS receiver system 10). The algorithm comprises the following steps.

An estimated noise floor of the GNSS receiver system 10, as a function of the current gain G_{recorder} of the RF signal processing unit 200 is calculated. Each value of the current gain G_{recorder} of the RF signal processing unit 200 (calculated as per equation (4)) corresponds to specific operational conditions of the RF signal processing unit 200, for which the estimated noise floor is calculated.

The calculation of the estimated noise floor depends on the total gain Gₜₒₜₐₗ and the total noise figure Fₜₒₜₐₗ of the GNSS receiver system 10 (parameters of the GNSS receiver system 10, such as the noise contribution and the gain contribution of each sub-component of the GNSS receiver system 10, are used for calculating Gₜₒₜₐₗ and Fₜₒₜₐₗ as per equations (3) and (2) respectively). The gain G₁ of the antenna 110 is set to one for the calculation of the estimated noise floor (to simulate the disconnection of the RF signal source 100 from the RF signal processing unit 200). Alternatively, the estimated noise floor of the GNSS receiver system 10 may be calculated based on experimental GNSS signal measurements, performed with the RF signal processing unit 200 disconnected from the RF signal source 100. A vector of the estimated noise floor values as a function of the gain G_{recorder} of the RF signal processing unit 200 is stored in memory.

Following is the equation for calculating the estimated noise floor N_{estimated}_{_{—}}_{dB} (expressed in decibels dB), as a function of the total gain Gₜₒₜₐₗ (expressed in decibels dB) and the total noise figure Fₜₒₜₐₗ (expressed in decibels dB) of the GNSS receiver system 10, with the gain G₁ of the antenna 110 set to 0 dB, so as to represent the situation where the RF signal processing unit 200 is disconnected from the RF signal source 100.

N_{estimated}_{_{—}}_{dB}=−174+Gₜₒₜₐₗ_{_{db}}(G₁_{_{db}}=0)+Fₜₒₜₐₗ_{_{dB}}(G₁_{_{dB}}=0) (6)

The measured noise floor is calculated, by measuring the power of the signal processed and generated at the output of the RF signal processing unit 200 under these circumstances. Following is the equation for calculating the measured noise floor N_{measured}_{_{—}}_{dB} (expressed in decibels dB), as a function of the measured power P_{measured}_{_{—}}_{dB} (expressed in decibels dB) of the signal processed and generated at the output of the RF signal processing unit 200, and its corresponding bandwidth B expressed in Hz.

N_{measured}_{_{dB}}=P_{measured}_{_{—}}_{dB}−10·log(B) (7)

The measured noise floor N_{measured}_{_{—}}_{dB} and the estimated noise floor N_{estimated} _{_{—}}_{dB} are compared to a detection threshold Detection_{threshold}, and a decision is made. If the difference between the measured noise floor and the estimated noise floor is greater than the detection threshold:

N_{measured}_{_{—}}_{dB}−N_{estimated}_{_{—}}_{dB}≧Detection_{threshold} (8)

The RF signal source 100 is determined to be connected to the RF signal processing unit 200. Otherwise, the RF signal source 100 is determined to be disconnected from the RF signal processing unit 200.

The vector of the estimated noise floor values stored in memory is used to select a value of the estimated noise floor N_{estimated}_{_{—}}_{dB} corresponding to the current gain of the RF signal processing unit 200 for which the measured noise floor N_{measured}_{_{—}}_{dB} is calculated.

The detection threshold Detection_{threshold} is selected based on empirical values to accommodate the most common range of antenna gain, antenna noise figure, and connection losses. For example, the minimal acceptable external gain (G₁*G₂ corresponding to the RF signal source 100) for signal detection may be set to 10 dB. A detection threshold of 3 dB has been found to be acceptable for a majority of the GNSS receiver systems performing GNSS signal recording. The minimal system gain for signal detection is set to the value for which the difference between the measured and estimated noise floors (with the RF signal receiver disconnected) is equal to the detection threshold.

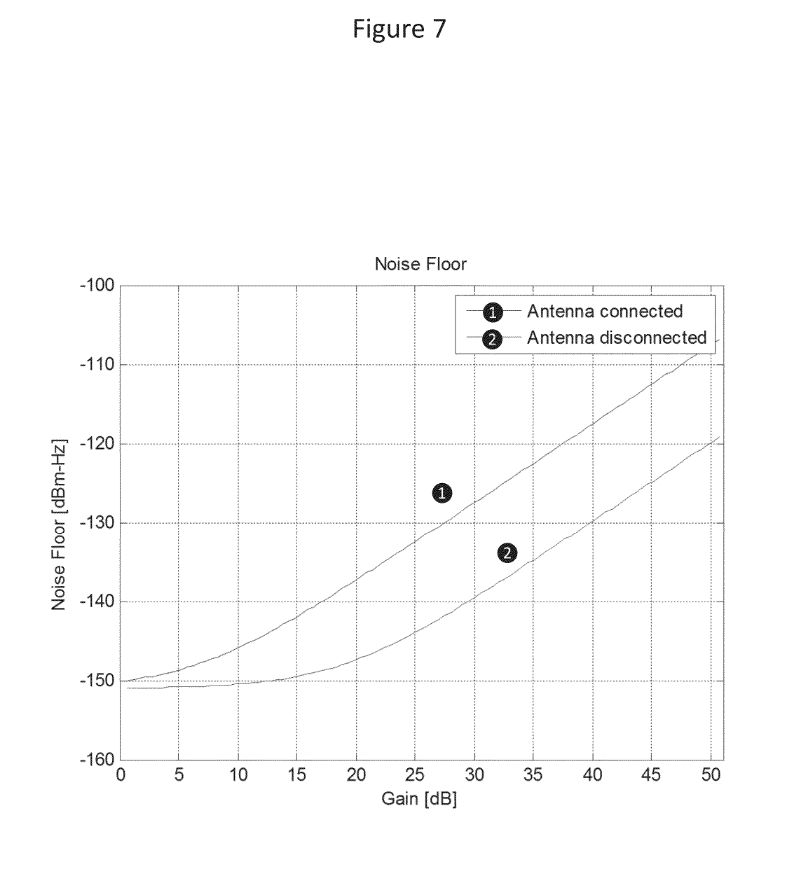

An example of values of measured noise floors with connected RF signal source 100 (antenna connected) and estimated noise floors with disconnected RF signal source 100 (antenna disconnected), as a function of the gain of the RF signal processing unit 200, is represented in FIG. 7.

The automatic detection of a disconnection of the RF signal processing unit 200 from the RF signal source 100 may be implemented by a combination of hardware (e.g. CPU, memory) and software (e.g. software implementing the algorithm for detecting the disconnection) included in the GNSS receiver system 10 or in the GNSS recording system 5.

### Determination of an Optimal Gain of a RF Signal Recorder

Another aspect of the present disclosure relates to the determination of an optimal gain of the RF signal processing unit 200, based on an estimated total noise figure and a jammer to signal ratio. The RF signal processing unit 200 is the component of the GNSS recording system 5, responsible for transforming an analog GNSS signal received by the RF signal source 100 into a digital GNSS signal, for further recording in the storage system 300.

The most common error made during GNSS signal recording consists in using an inappropriate gain for the RF signal processing unit 200. The gain of the RF signal processing unit 200 is generally selected by a user of the GNSS recording system 5. But the GNSS signal is so weak, that it is under the noise floor of the RF signal in processing unit 200. Thus, one needs to have a specific background and experience in the RF/GNSS field, to be able to choose an optimal gain for the RF signal processing unit 200. In the present system, in order to avoid recording issues due to an inappropriate selection of the gain of the RF signal processing unit 200, assistance is provided to choose an optimal gain value. With this approach, users do not need to have as specific background in the RF/GNSS field, to adjust the gain value to its optimal value.

Reference is now specifically made to FIG. 5. The GNSS receiver system 10 may be represented as a cascaded system of active/passive elements. FIG. 5 illustrates the GNSS receiver system 10, represented as a 7-stages cascaded system. This representation is for illustrations purposes only, as the GNSS receiver system 10 may include less, more, arid different active/passive elements.

The first two stages are sub-components of the RF signal source 100. They consist of an antenna 110 and a cable 120. The RF signal source 100 receives an analog GNSS signal, via the antenna 110, and transmits this analog GNSS signal to the RF signal processing unit 200, via the cable 120.

The five next stages are sub-components of the RF signal processing unit 200. They consist of a T-bias 210, a wideband filter 220, a pre-amplifier 230, an image reject filter 240, and a Vector Signal Analyzer (VSA) 250. As mentioned previously, the VSA 250 further digitizes the processed analog GNSS signal and generates a digital GNSS signal (for this purpose, the VSA further includes an Analog/Digital Converter).

Each sub-component corresponds to a stage n, with its own noise contribution Fₙ and its own gain contribution Gₙ, to the global GNSS receiver system 10. The total noise figure Fₜₒₜₐₗ and the total gain Gₜₒₜₐₗ of the GNSS receiver system 10 are calculated by taking into consideration the contribution at each stage n

The respective noise contribution and gain contribution of the components at each stage n are represented as follows: F₁ and G₁ for the antenna 110, F₂ and G₂ for the cable 120, F₃ and G₃ for the T-bias 210, F₄ and G₄ for the wideband filter 220, F₅ and G₅ for the pre-amplifier 230, F₆ and G₆ for the image reject filter 240, and F₇ and G₇ for the VSA 250.

The total noise figure Fₜₒₜₐₗ of the GNSS receiver system 10 is computed as per the following equation:

$${F}_{total} = {F}_{1} + \frac{( {F}_{2} - 1 )}{{G}_{1}} + \frac{( {F}_{3} - 1 )}{{G}_{1} \cdot {G}_{2}} + \frac{( {F}_{4} - 1 )}{{G}_{1} \cdot {G}_{2} \cdot {G}_{3}} + \frac{( {F}_{5} - 1 )}{{G}_{1} \cdot {G}_{2} \cdot {G}_{3} \cdot {G}_{4}} + \frac{( {F}_{6} - 1 )}{{G}_{1} \cdot {G}_{2} \cdot {G}_{3} \cdot {G}_{4} \cdot {G}_{5}} + \frac{( {F}_{7} - 1 )}{{G}_{1} \cdot {G}_{2} \cdot {G}_{3} \cdot {G}_{4} \cdot {G}_{5} \cdot {G}_{6}} \qquad ( 2 )$$

The total gain G_{receiver} of the GNSS receiver system 10 is computed as per the following equation:

G_{receiver}=G₁·G₂·G₃·G₄·G₅·G₆·G₇ (3)

The gain Gₜᵣₑₐₜₘₑₙₜ of the RF signal processing unit 200 is computed as per the following equation:

Gₜᵣₑₐₜₘₑₙₜ =G₃·G₄·G₅·G₆·G₇ (4)

The gain Gₙ of each stage n remains constant during the processing of the analog GNSS signal, except for the gain G₅ of stage 5, corresponding to the pre-amplifier 230 of the RF signal processing unit 200. The gain G₅ varies in a pre-determined range of values depending on the characteristics of the pre-amplifier 230. In fact, the noise figure and/or the dynamic range of the GNSS receiver system 10 are selected by tuning the gain G₅ of the pre-amplifier 230. There is a tradeoff in the selection of the value of the gain G₅, between the best noise figure and the dynamic range of the GNSS receiver system 10. In the case of GNSS signals, it is more common to use the Jammer to Signal Ratio (JSR) instead of the dynamic range. In general, the JSR decreases when the gain of the RF signal processing unit 200 increases, while the value of the noise figure decreases when the gain of the RF signal processing unit 200 increases.

The computation of the optimal gain for the RF signal processing unit 200 is performed through the following steps.

With reference to equation 2, the user specifies operational parameters for the RF signal source 100: antenna noise figure (NF_antenna), antenna gain (G_antenna), connection losses between the antenna output and RF signal recorder input (L_cable).

The user specifies operational parameters for the RF signal processing unit 200: losses due to the wideband filter (L_wideband) and the image rejection filter (L_image_rej) for each of the recording channels.

The gain G_{receiver} of the RF signal processing unit 200 is computed as per equation (4). G_{receiver} varies with the value of the gain G₅ of the pre-amplifier 230, the other parameters having fixed values.

The total noise figure Fₜₒₜₐₗ of the GNSS receiver system 10 is computed as per equation (2). Fₜₒₜₐₗ varies with the value of the gain G₅ of the pre-amplifier 230, the other parameters having fixed values. Then, the values of Fₜₒₜₐₗ are further represented as a function of G_{receiver}. And a steady-state (converged noise figure value) is determined for Fₜₒₜₐₗ. It represents the best value of Fₜₒₜₐₗ for the given setup of the GNSS receiver system 10.

A nominal JSR is estimated as a function of the gain G_{receiver} of the RF signal processing unit 200. For this purpose, a maximal acceptable interference value (i.e. Continuous Wave signal) Iₘₐₓ at the input of the VSA 250 (it is determined by the hardware specification and depends from reference levels) is recalculated to the antenna (110) input: Iₐₙₜₑₙₙₐ_{_{—}}ᵢₙₚᵤₜ=Iₘₐₓ/Gₜₒₜₐₗ, where the total gain Gₜₒₜₐₗ of the GNSS receiver system 10 is computed as per equation (3). The nominal GNSS signal power at antenna (110) input Sₐₙₜₑₙₙₐ_{_{—}}ᵢₙₚᵤₜ is considered to be equal to −130 dBm (decibel-milliwatt). JSR is calculated as follows:

$$JSR - \frac{{I}_{antenna input}}{{S}_{antenna \_ input}} \qquad ( 5 )$$

Since G_{receiver} is proportional to Gₜₒₜₐₗ (G_{receiver}=Gₜₒₜₐₗ/(G₁*C₂)), the values of JSR may further be represented as a function of G_{receiver} (i.e. JSR is inversely proportional to G_{receiver} as JSR+G_{receiver} is limited by P_{MAX}−allowed power level).

(J_{IS}_{_{—}}ₐₛ+G_{STS}_{_{—}}_{dB})≦P_{MAX}_{_{—}}ₐₛ

A range of values of the gain G_{receiver} of the RF signal processing unit 200 is determined, for which the total noise figure Fₜₒₜₐₗ is degraded (against the previously determined best value of Fₜₒₜₐₗ) by some predefined, maximum or acceptable value (for example, from 0.3 to 0.5 dB as suggested or requested in related standards). Having the determined best value of Fₜₒₜₐₗ, and the predefined acceptable degradation, a range of acceptable values for Fₜₒₜₐₗ is determined. And since Fₜₒₜₐₗ has been represented as a function of G_{receiver}, a corresponding range of acceptable values for G_{receiver} is determined.

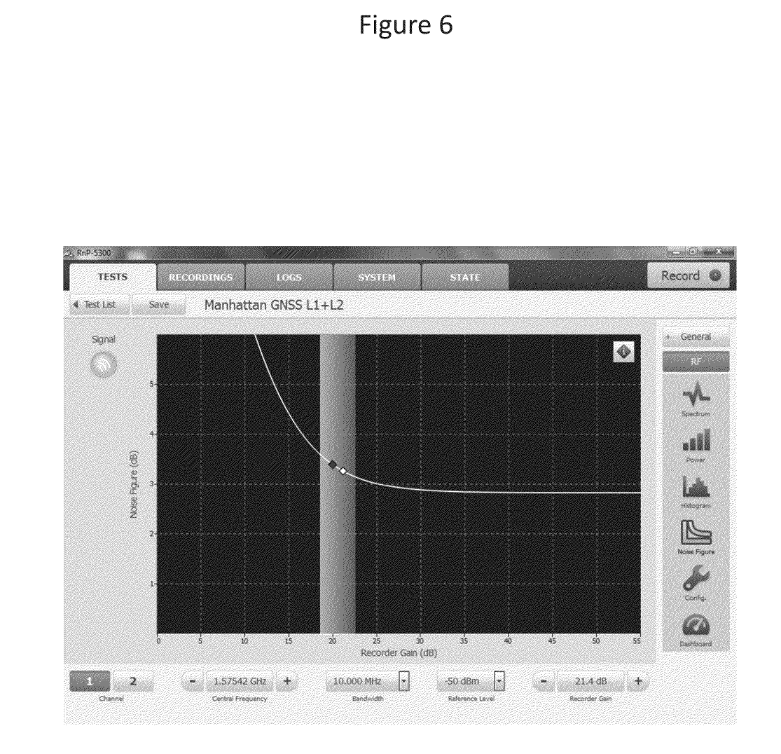

All the aforementioned calculations are performed without the involvement of the user of the GNSS receiver system 10. The user is only presented with the range of acceptable values for and may select a value within this range. Then, the value of the gain G₅ of the pre-amplifier 230 is set, so that the selected value for G_{receiver} is met. FIG. 6 illustrates a screen with a graph representing the total noise figure Fₜₒₜₐₗ (vertical axis) versus the gain G_{receiver} of the RF signal processing unit 200 (horizontal axis), with an indication of the optimal range of values for the user.

Additionally, for each value of G_{receiver} within the range of acceptable values (the light gray window in FIG. 6), the corresponding value of JSR may also be presented to the user (since the values of JSR have been previously computed and represented as a function of G_{receiver}). As previously mentioned, in the case of GNSS signals, it is more common to use the JSR instead of the dynamic range (gain value).

On the graph represented in FIG. 6, the light gray window corresponds to a range of acceptable values for that particular example, the range of acceptable values corresponding to the optimal trade-off between the best possible total noise figure Fₜₒₜₐₗ (sensitivity) and the gain G_{receiver}/the JSR supported by the RF signal processing unit 200. The user selects the gain G_{receiver} of the RF signal processing unit 200, by simply positioning a tunable indicator on the optimal zone. The selected combination of parameters insures a good signal recording (with maximal gain/minimal JSR and minimal degradation of signal to noise ratio).

In an alternative embodiment, an optimal gain G_{receiver} of the RF signal processing unit 200 is automatically selected (without user interaction), based on an optimal trade-off between the total noise figure Fₜₒₜₐₗ (sensitivity) of the GNSS receiver system 10 and the gain G_{receiver}/JSR (dynamic range) of the RF signal processing unit 200.

This alternative embodiment is similar to the previously described embodiment. The only difference is that the gain G_{receiver} of the RF signal processing unit 200 is selected automatically, once the range of acceptable values for Fₜₒₜₐₗ/the corresponding range of acceptable values for G_{receiver} is determined.

For example, the selected value of G_{receiver} corresponds to a value of Fₜₒₜₐₗ in the middle of the determined range of acceptable values for Fₜₒₜₐₗ. Then, the value of the gain G₅ of the pre-amplifier 230 is set, so that the selected value for G_{receiver} is met. And this selected gain value G_{receiver} of the RF signal processing unit 200 is kept constant during the processing and recording of GNSS signals (this ensures acceptable minimal degradation of the signal to noise ratio, while keeping an acceptable high JSR).

The determination of the optimal gain of the RF signal processing unit 200 may he implemented by a combination of hardware (e.g. CPU, memory) and software (e.g. software implementing the calculation of the optimal gain) included in the GNSS receiver system 10 or the GNSS recording system 5, or alternatively by a standalone computer.

### Optimization of the Bit Resolution of a Recorded Digital GNSS Signal

Reference is now made back to FIG. 1. In yet another particular embodiment of the present disclosure, the bit resolution of a recorded digital GNSS signal, related to a received analog GNSS signal, is optimized. The optimization of the bit resolution allows a reduction of the amount of data to be stored, when the recorded digital GNSS signal is stored by the RF signal processing unit 200 in the storage system 300.

Reference is now concurrently made to FIGS. 1 and 5. The RF signal processing unit 200 includes the Vector Signal Analyzer (VSA) 250. The VSA 250 receives the analog GNSS signal via the T-bias 210, the wideband filter 220, the preamplifier 230 and the image reject filter 240, and convert to the baseband digital IQ signal. Conventional VSAs operate on fixed high bit resolution to cover a large spectrum of applications. The typical bit resolution is 12, 14, or 16 bits. Applied to GNSS signals, it may not be optimal to use such a high bit resolution.

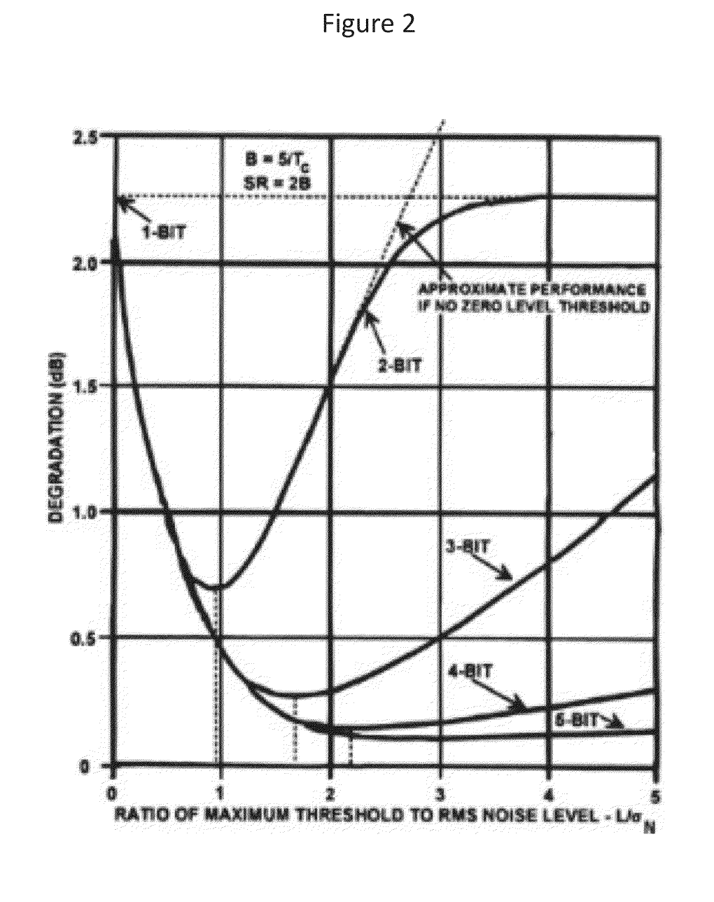

Specifically, the quantization mechanisms of analog GNSS signals allow for a lower bit resolution, with little effect on signal quality. FIG. 2 (extracted from Global Positioning System: Theory and Applications, Volume 1, by James J. Spiker) illustrates how the Signal to Noise Ratio (SNR) is affected by the bit resolution. With more than a 4-bit resolution, there are little improvements to the SNR. In some cases, a degradation of 0.5 dB (decibel), for a 2-bit resolution, or even 2 dB, for a 1-bit resolution, is acceptable. The only reason to operate with higher bit-rates is to be able to record interferences and jammers, which require a higher dynamic range. For this purpose, the VSA 250 of the RF signal processing unit 200 operates on a 16-bit basis. However, the baseband digital GNSS signal stored in the storage system 300, may be converted to a lower bit resolution, when no interferences or jammers are present.

In a majority of cases, the recording of analog GNSS signals is done under the following typical conditions: no intentional jammers are present, and interferences are lower than 10 dB of Interference to Signal Ratio. In these conditions, a 4-bit resolution keeps the signal quality comparable to a 16-bit resolution. The usage of a 4-bit resolution instead of a 16-bit resolution has a significant impact on data storage requirements. Specifically, a 4-bit resolution requires four times less data storage space than a 16-bit resolution. Optimization of the data storage is useful, considering the large amount of data generated by the recording of baseband digital GNSS signals (e.g. one hour of recording with 50 MHz (Mega Hertz) of bandwidth generates 880 GB (Giga Bytes) of data).

Following is an algorithm which allows data storage at a lower bit-rate, when an Analog Digital Converter (ADC) of the VSA 250 operates on a fixed 16-bit resolution. The ADC is a component of the VSA, which is specifically responsible for performing the conversion of the processed analog GNSS signal into a digital GNSS signal. The ADC generates a digitized GNSS signal with a 16-bit resolution, based on the processed analog GNSS signal. The algorithm includes a data processing step, and a bit-stream formation step. The data processing step consists in transforming a 16-bit resolution digital signal to a lower bit resolution digital signal, with minimal signal degradation. The data processing step may be performed by the processor 400 of the GNSS recording system 5, or by a processor (not shown) of the GNSS receiver system 10. A simple bit truncation is not sufficient, to avoid signal degradation or loss of information.

The digital signal is processed separately on I and Q samples. The notion of I and C samples is well known in the art of RF signal processing. It consists in two modulating signals representative of the received analog RF signal, where the I and Q samples are Cartesian translations of the polar amplitude and phase waveforms.

First, a desired bit-resolution is selected for the data storage. A typical resolution is 4 bits; but other resolutions like 3, or even 2 bits, may be selected as well. The desired bit-resolution may be selected upon design of the GNSS recording system 5 and be hard-coded, or be selected by a user of the GNSS recording system 5 through an input unit 500.

Then, a Root Mean Square (RMS) of the 16-bit I samples and the 16-bit Q samples of the digital signal is computed by the processor 400 and stored either in the storage system 300, or in a temporary memory (not shown on FIG. 1).

A maximum threshold L is computed. As illustrated in FIG. 2, an optimal value of a ratio of the maximum threshold L to the RMS can be determined for a specific bit-resolution based on a chart such as the one shown. The optimal value of the ratio guarantees a minimal SNR degradation. The maximum threshold L is obtained by multiplying the optimal value of the ratio by the RMS.

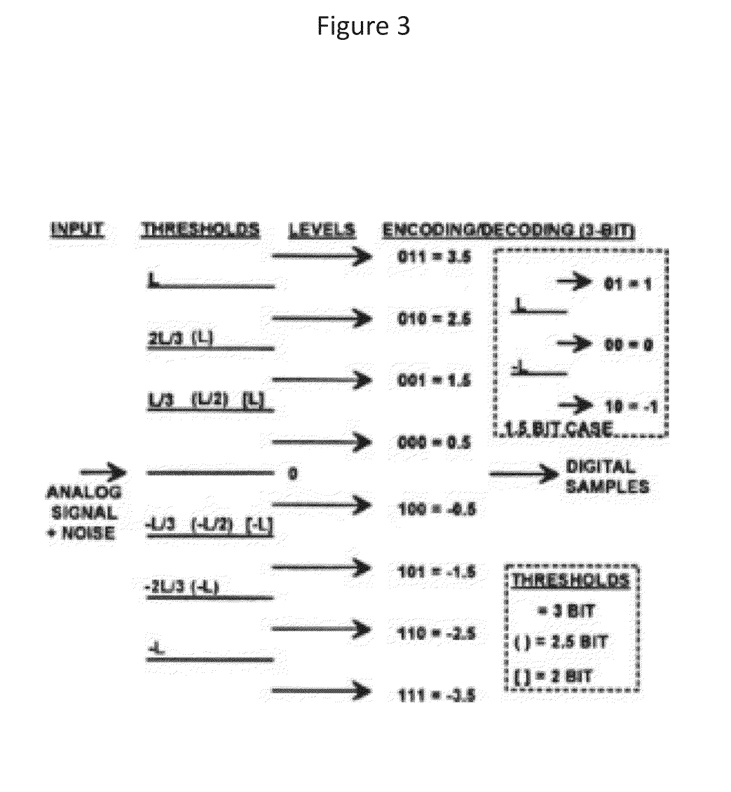

The digital signal (I and Q samples) is re-quantized, based on an algorithm illustrated in FIG. 3 (the example in FIG. 3 shows re-quantization with 3-bit resolution) and the graph of FIG. 2. The 16-bit resolution I and Q samples are transformed in selected-bit (e.g. 3-bit) resolution I and Q samples, for further data storage.

In a playback mode, the low-bit resolution digital signals, stored in the data storage entity, are decompressed (converted back to a 16-bit resolution). For this purpose, the most significant bits are padded by 0 for positive values, and padded by 1 for negative values. To return to the original 16-bit resolution format (before data storage), 1 is added to positive values. Further, to keep the same power on decompressed 16-bit resolution digital signals, as for the original 16-bit resolution digital signals, the decompressed digital signals are resealed by multiplying the I and Q samples respectively by a factor k, computed as follows (n-bit is the low-bit resolution, e.g. 3):

$$k = \frac{{RMS}_{16 - bit}}{{RMS}_{n - bit}} \qquad ( 1 )$$

The RMS of the 16-bit I samples and Q samples has been previously computed and stored. The RMS of the n-bit (e.g. 3-bit) I samples and 0 samples is determined on the 1 and 0 samples to be decompressed.

Following is an example of a 2-bit resolution re-quantization.

Based on FIG. 2, the optimal value of the ratio of the maximum threshold to RMS is approximately 0.9 for the 2-bit resolution curve. We consider, for exemplary purposes, that the RMS of the original 16-bit resolution 1 samples and Q samples digital signals is 300. The maximum threshold max_threshold is 0.9*300=270.

Following is an exemplary algorithm for re-quantization of I samples data (a similar algorithm is applicable to Q samples data):

% for k = 1:length(l_read)
% if l_read(k)>max_threshold
% l_write(k) = 2;
% elseif (l_read(k)<=max_threshold)&(l_read(k)>0)
% l_write(k) = 1;
% elseif (l_read(k)<=0)&(l_read(k)>=−max_threshold)
% l_write(k) = −1;
% elseif l_read(k)<-max_threshold
% l_write(k) = −2;
% else
% disp(‘There is a problem to convert the signal...’),
% end
% end

Where I_write is the re-quantized data, and I_read is the original 16-bit data. The I_write value is coded on 2-bit as follows:
2=‘01’
1=‘00’
−1=‘11 ’
−2=‘10’

As illustrated by the previous algorithm, any value of the original 16-bit I or Q sample is determined to be in one of the four intervals: max threshold or greater, 0 to max_threshold, 0 to -max_threshold, -max _threshold or lower. And a 2bit value is allocated to each of the four intervals to represent the 2-bit I or sample.

In playback mode, 1 is added to the positive values to form the 16-bit resolution format, and the 14 most significant bits are padded with 0:
‘00’+1=0000 0000 0000 0001
‘01’+1=0000 0000 0000 0010

Negative values are padded with 1 as follows, to form the 16-bit resolution format:
‘11’=1111 1111 1111 1111
‘10’=1111 1111 1111 1110

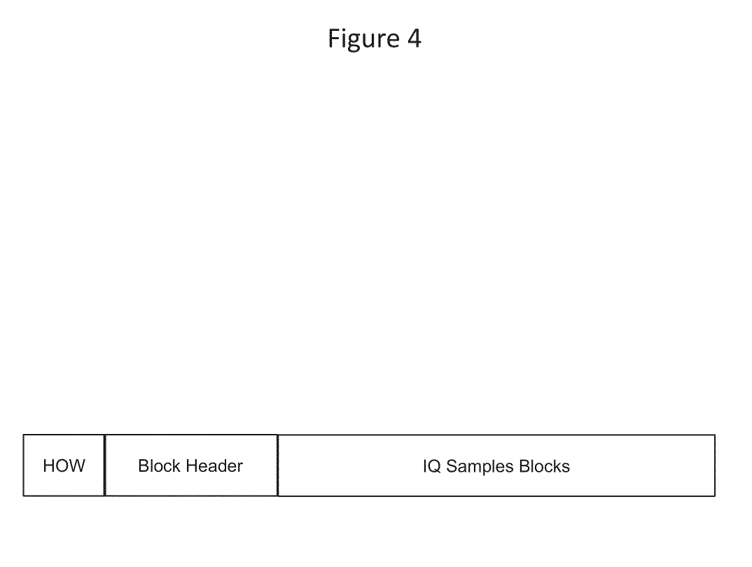

FIG. 4 illustrates an example of a format for storing the re-quantized data (I and Q samples) in the storage system 300. The format comprises a Handover section (HOW), a Block Header, and Q Samples Blocks.

The Handover section (HOW) contains the length of the Block Header. The Block Header carries information about the selected low-bit resolution, the number of IC) Samples Blocks (each IQ Samples Block contains 4096 samples of I and Q values), and the RMS value of the original 16-bit resolution digital signals for each IQ Samples Block. The Block Header is followed by the appropriate number (as indicated in Block Header) of IQ Samples Blocks. This format allows for flexible bit-resolution from one IQ Samples Block to another (the bit-resolution may be different for each individual IQ Samples Block).

The optimization of the bit resolution of the recorded digital GNSS signal may be implemented by a combination of hardware (e.g. CPU, memory) and software (e.g. software implementing the optimization algorithm) located in the GNSS recording system 5. For instance, it may be implemented by the processor 400 and the storage system 300. The processor 400 may thus be used for re-quantizing the digital GNSS signals and for decompressing the re-quantized GSNN signals.

### Dynamic Adaption of the Bit Resolution of a Recorded Digital Signal

In yet another aspect of the present disclosure, the bit resolution of a recorded digital GNSS signal is dynamically adapted. The dynamic adaptation of the hit resolution allows a reduction of the amount of data to be stored in the storage system 300.

As previously mentioned, the ADC of VSA 250 of the RF signal processing unit 200 generally operates on a 16-bit resolution (the received analog GNSS signal is converted to a corresponding 16-bit digital GNSS signal). The conversion is performed at the 16-bit resolution, to ensure a 80 dB of dynamic range of the RF signal processing unit 200. Such a dynamic range is adapted for recording of the digital GNSS signal in presence of strong interferences and jammers.

When the GNSS signal is recorded, interferences and/or jammers may appear randomly, during the recording time. Keeping the signal resolution permanently at a 16-bit resolution may require important data storage capacity. For example, recording two channels with 50 MHz of bandwidth per channel at a 16-bit resolution requires around 1.7 TB (Terabyte) of data per hour. In the context of monitoring or surveillance systems, recording of digital GNSS signals is usually performed in a continuous mode for hours (or even days). In this context, the data storage capacity of the storage system 300 becomes a limiting factor.

Following is an algorithm to enable the optimized recording, with no degradation, of a digital GNSS signal potentially comprising interferences and/or jammers. The algorithm is adapted to minimize the size of the recorded data, stored in the storage system 300. The algorithm consists in dynamically adapting the bit resolution of the recorded digital GNSS signal, based on the presence or absence of interferences and/or jammers. The recorded digital GNSS signals consists of I samples and Q samples processed separately, according to the following steps.

The digital GNSS signals at, the ADC output have a 16-bit resolution. These digital GNSS signals are pre-processed by the processor 400, to detect the presence of interferences and/or jammers in the digital GNSS signal. The pre-processing is performed on a fixed number of samples (e.g. on 4096 I and Q samples). A RMS value, a maximal value in time domain, and a maximal value in frequency domain, are calculated separately for I and Q for a limited number of samples. The calculated values are compared with pre-defined thresholds. The pre-defined thresholds may be measured during a calibration phase of the RF signal processing unit 200, in absence of interferences and jammers. Alternatively, the pre-defined thresholds may be calculated, based on parameters corresponding to the configuration of the RF signal processing unit 200. If the calculated values (RMS and/or maximal value in time domain and frequency domain) are above their pre-defined threshold, the digital GNSS signals (the fixed number of I and Q samples) are recorded with the original 16-bit resolution. If not, the digital GNSS signals (the fixed number of I and Q samples) are recorded with a reduced 4-bit resolution. An exemplary embodiment of a digital signal conversion from a 16-bit resolution to a lower-bit resolution, with acceptable signal degradation, has been described previously.

The digital GNSS signals with 16-bit (original) or 4-bit (re-quantized as previously discussed) resolution are stored in the storage system 300. The format described, in relation to FIG. 4, may be used for the storing the digital GNSS signals (original and re-quantized). With this format, the digital GNSS signals are stored in IQ Samples Blocks (respectively containing 4096 IQ samples), preceded by Block Headers which carry information about the bit resolution used in the following IQ Samples Block(s) of data. All the data in a specific IQ Samples Block have the same resolution: either 16-bit or 4-bit.

In playback mode, the blocks of data with a 4-bit resolution are decompressed (converted back to 16-bit resolution), as described previously in the description.

The dynamic adaptation of the bit resolution of the recorded digital GNSS signal may be implemented by a combination of hardware (e.g. processor 400, memory) and software (e.g. software implementing the optimization algorithm and executed by the processor 400) located in the GNSS recording system 5.

Although an example of a dynamic adaptation from a 16-bit to a 4-bit resolution has been given, it may generalized to a dynamic adaptation from a n-bit to a s-bit resolution where n is greater than s.

### Synchronization of Multiple GNSS Recording Systems

In another aspect of the present disclosure, multiple geographically separated GNSS recording systems are synchronized, using Global Positioning System (GPS) reference time and a communication means, for example an Internet connection.

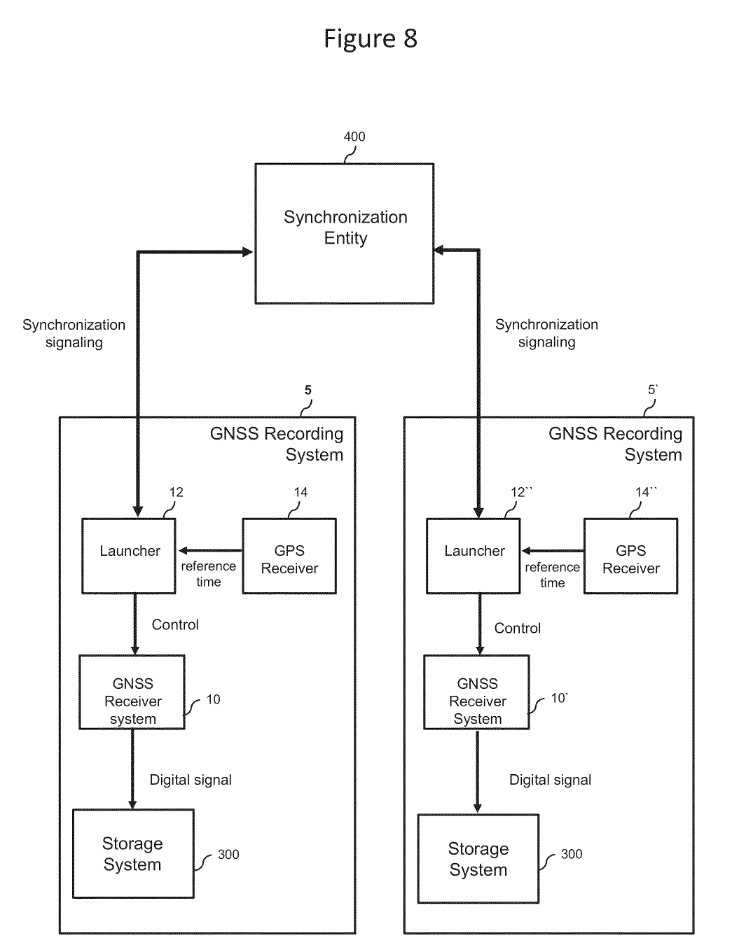

Reference is now made to FIG. 8. One use case for GNSS signal recording is Differential GNSS. In this case, the GNSS signal is acquired by multiple (at least two) geographically separated GNSS recording systems 5 and 5′. The recording of the received GNSS signal, in the context of Differential GNSS, is performed by multiple synchronized GNSS recording systems.

The synchronization of the multiple GNSS recording systems relies on a dedicated synchronization algorithm executed by the GNSS recording systems 5 and 5′, the synchronization algorithm making use of GPS reference time. Each of the GNSS recording systems 5 and 5′ has a GPS receiver (14 and 14′ respectively) with a GPS disciplined reference clock, and an Internet connection (or any other appropriate communication means). The GPS disciplined reference clock is locked on a GPS signal acquired by the GPS receiver, and supplies the same reference time to each of the GNSS recording systems 5 and 5′.

Further, the synchronization of the multiple GNSS recording systems is configured and controlled by a synchronization entity 400, which is communicating with the multiple GNSS recording systems 5 and 5′ via their Internet connection (or any other appropriate communication means). The synchronization entity 400 may be a standalone entity (e.g. a standalone computer with communication means), or may be embedded in one of the GNSS recording systems 5 and 5″.

In addition, the synchronization entity 400 may perform additional control and monitoring of the GNSS recording systems 5 and 5′, using feedback information sent by the GNSS recording systems (e.g. monitoring of frequency and time domain signal parameters, time and recording process, hardware state, etc).

FIG. 8 illustrates an exemplary embodiment of the synchronization entity 400 communicating with two GNSS recording systems 5 and 5′, exchanging synchronization signaling in order to synchronize the start of a recording of received analog GNSS signal by both GNSS recording systems 5 and 5′. Although only two GNSS recording systems 5 and 5′ have been represented, any number of these may be under the control of the synchronization entity 400.

Each GNSS recording system 5 and 5′ includes the GPS receiver 14, 14′, and a launcher 12 and 12′. The launchers 12 and 12′ include hardware (e.g. CPU, memory) and software (e,g. software implementing a synchronization algorithm) not represented in FIG. 8, to control and synchronize the recording of GNSS signals.

Each GNSS recording system 5 and 5′ includes the GNSS receiver system 10 and 10′ for receiving, treating and digitalizing the analog GNSS signal (not represented in FIG. 8 for simplification purposes). The resulting digital GNSS signal is stored in the storage system 300 and 300′.

Based on the synchronization signaling exchanged with the synchronization entity 400 and on the reference time provided by the GPS receivers 14 and 14′, the launchers 12 and 12′ control the receipt, processing of the analog GNSS signal by the GNSS receiver system 10 and 10′. Thus, the GNSS recording systems 5 and 5′ are synchronized to start the recording of the GNSS signal at the same reference time. Similarly, the launchers 12 and 12′ may also control the start of the reception of the GNSS signal by the GNSS receiver system 10 and 10′ if they include active components.

The synchronization entity 400 is configured for each specific GNSS signal recording scenario (e.g. via an input unit 500 as shown on FIG. 1). The configuration includes: selection of the GNSS recording systems 5 and 5′ to be synchronized, indication that the selected GNSS recording systems operate with an external synchronization trigger, and determination of the start of the recording. The recording may start immediately, or may be programmed to start some time in the future.

In the case of an immediate start of the recording, the following sequence takes place.

A configuration request is sent by the synchronization entity 400 to the selected GNSS recording systems (e.g. 5 and 5′). For instance, the configuration request includes an indication that the GNSS recording systems 5 and 10′ shall operate with an external synchronization trigger. The configuration request may include an indication to use GPS time for synchronization purposes. The configuration request may further include an indication to use a GPS Pulse Per Second (1PPS) pulse (frequency of 1 Hertz).

Upon reception of the configuration request, the launchers 12 and 12′ perform the appropriate configuration accordingly. For instance, the GPS receivers 14 and 14′ are activated and configured to generate the GPS 1PPS pulse. The reference clocks of the launchers 12 and 12′ are locked on the GPS time (GPS one PPS pulse) delivered by the GPS receivers 12 and 12′. The GNSS recording systems 5 and 5′ are armed, and ready to start the recording.

Once the appropriate configuration is accomplished, each GNSS recording system 5 and 5′ sends an acknowledgement message to the synchronization entity 400, indicating that the requested configuration has been performed. When acknowledgement messages have been received from all the selected GNSS recording systems (e.g. 5 and 5′), the synchronization entity 400 determines that all the selected GNSS recording systems (e.g. 5 and 5′) are ready to start the GNSS signal recording in a synchronized manner.

Then, the synchronization entity 400 initiates the start of the recording (for example via a user interaction). For this purpose, the synchronization entity 400 sends a recording request to the selected GNSS recording systems (e.g. 5 and 5′). Upon reception of the recording request, the GNSS recording systems 5 and 5′ start the recording of the GNSS signal, synchronized on the next GPS 1PPS pulse after reception of the recording request. More specifically, the launchers 12 and 12′ force the start of the recording by the GNSS receiver system 10 and 10′ on the next GPS 1PPS pulse generated by the GPS receivers 14 and 14′.

In the general case, the next GPS 1PPS pulse is the first GPS 1PPS pulse after reception of the recording request. However, the next GPS 1PPS pulse may also any number of GPS 1PPS pulses (e.g. the first, second, third, fourth, etc) after reception of the recording request. This number may be indicated in either the configuration request or recording request sent by the synchronization entity 400. However, the next GPS 1PPS pulse is the same for all the selected GNSS recording systems (e.g. 5 and 5′), in order to perform the synchronized GNSS signal recording,

In the case of a recording programmed to start some time in the future, the procedure is similar to the procedure for immediate start of the recording. However, the start of the recording is initiated related to Coordinated Universal Time (UTC time). The UTC time is supplied by the GPS receiver 14 and 14′. Once the UTC time supplied by the GPS receiver 14 and 14′ is equal to a specific UTC time, the GNSS receiver system 10 and 10′ are forced by the launchers 12 and 12′ to start the recording on the next GPS 1PPS pulse generated by the GPS receiver 14 and 14′. The next GPS 1PPS pulse may be a number of GPS 1PPS pulses (e.g. the first, second, third, fourth, etc) after the specific UTC time.

The specific UTC time is determined at the synchronization entity 400 (for example, via a user interaction). And the specific UTC time is transmitted in the configuration request or in the recording request sent to the selected GNSS recording systems (e.g. 5 and 5′) by the synchronization entity 400.

Although the present disclosure has been described in the foregoing description by way of illustrative embodiments thereof, these embodiments can be modified at will, within the scope of the appended claims without departing from the spirit and nature of the appended claims.

What is claimed is:

1. A method for reducing a bit resolution of a digital signal, the method comprising:
receiving at a Radio Frequency (RF) recording system a digital signal representative of an RF analog signal, wherein the received digital signal is encoded with a n-bit resolution;
selecting a re-quantizing resolution for the digital signal, wherein the re-quantizing resolution is an s-bit resolution with s lower than n;
calculating a Root Mean Square (RMS) value of the digital signal;
determining for the selected s-bit resolution a value representing a ratio of a maximal threshold to the RMS value;
calculating the maximum threshold as a product of the RMS value by the determined value of the ratio; and
processing, based on the maximum threshold value and on the s-bit resolution value, the digital signal received with the n-bit resolution to generate re-quantized digital signal with the s-bit resolution.

2. The method of claim 1, wherein the RF analog signal is a Global Navigation Satellites System analog signal and the RF recording system is a Global Navigation Satellites System recording system.

3. The method of claim 1, wherein the RMS value is calculated for I and Q images of the digital signal.

4. The method of claim 1, wherein n equals 16 and s equals 3.

5. The method of claim 1, further comprising:
processing the digital signal to calculate a maximal value in time domain of the digital signal, and a maximal value in frequency domain of the digital signal;
determining that a pre-defined condition is met, wherein the pro-defined condition consists in a combination of at least one of: the RMS value is above a first pre-defined threshold, the maximum value in time domain is above a second pre-defined threshold, and the maximum value in frequency domain is above a third pre-defined threshold; and
if the pre-defined condition is met, not processing the digital signal to generate re-quantized digital signal with the s-bit resolution encoded with the n-bit resolution.

6. The method of claim 5, wherein the maximal value in time domain and in frequency domain of the digital signal are calculated on I and Q images of samples of the digital signal.

7. The method of claim 5, wherein the RF analog signals are Global Navigation Satellite Systems analog signals and the RF recording system is a Global Navigation Satellite Systems recording system.

8. A method for determining an optimal gain of a Global Navigation Satellites Systems Radio Frequency (RF) signal recorder, the method comprising:
calculating values of a gain of a RF signal recorder as a product of gain values of sub-components of the RF signal recorder, the RF signal recorder being adapted to transform an analog RF signal received from a RF signal receiver into a digital signal, and wherein the gain values of the sub-components are fixed, except for the gain value of one sub-component which varies in a pre-determined range;
calculating values of a total noise of the RF signal recorder and RF signal receiver as a function of gain values and noise values of sub-components of the RF signal receiver and the RF signal recorder, wherein the gain values and noise values of the sub-components are fixed, except for the gain value of the one sub-component which varies in the pre-determined range;
calculating the values of the total noise of the RF signal recorder and RF signal receiver as a function of the values of the gain of the RF signal recorder;
selecting a range of values of the total noise of the RF signal recorder and RF signal receiver representing an optimal mode of operation of the RF signal recorder; and
determining a range of values of the gain of the RF signal recorder corresponding to the selected range of values of the total noise of the RF signal recorder and RF signal receiver.

9. The method of claim 8, wherein an operational value is selected among the determined range of values of the gain of the RF signal recorder, and the gain value of the one sub-component which varies in the pre-determined range is set to a value for which the gain of the RF signal recorder is equal to the selected operational value.

10. The method of claim 8, wherein the RF signal is a GNSS signal.

11. A method for automatically detecting disconnection of a RF signal recorder from a Global Navigation Satellites Systems (GGSN) Radio Frequency (RF) signal receiver, the method comprising:
receiving at the RF signal recorder a RF signal;
measuring at the RF signal recorder a signal power of the RF signal;
calculating a measured noise floor as a function of the measured signal power of the RF signal and of a recording bandwidth of the RF signal;
calculating a difference between the measured noise floor and an estimated noise floor, wherein the estimated noise floor is an estimation of the value of a noise floor when the RF signal recorder is disconnected from the RF signal receiver; and
determining that the RF signal recorder is disconnected from the RF signal receiver when the difference is lower than a pre-defined detection threshold.

12. The method of claim 11, wherein the estimated noise floor is calculated as a function of a total gain and a total noise figure of a GNSS recording system comprising the RF signal recorder and the RF signal receiver, with the RF signal recorder disconnected from the RF signal receiver.

13. The method of claim 11, wherein the estimated noise floor is measured when the RF signal recorder is disconnected from the RF signal receiver.

14. The method of claim 11, wherein the RF signal is a GNSS

15. A method for synchronizing multiple RF recording systems, the method comprising:
receiving at multiple RF recording systems a configuration request from a synchronization entity;
sending an acknowledgement from each of the multiple RF recording systems to the synchronization entity;
receiving at each of the multiple RF recording systems a recording request from the synchronization entity; and
starting a recording of a RF signal at each of the multiple RF recording systems, the start of the recording being synchronized on a Global Positioning System (GPS) one Pulse Per Second (PPS) pulse selected from: a next GPS one PPS pulse after reception of the recording request or a next GPS one PPS pulse after a specific Coordinated Universal Time (UTC) time;
wherein the specific UTC time is indicated in one of the configuration request or the recording request.

16. The method of claim 15, wherein the next GPS one PPS pulse after reception of the recording request is the first GPS one PPS pulse after reception of the recording request and the next GPS one PPS pulse after the specific UTC time is the first GPS one PPS pulse after the specific UTC time.

17. The method of claim 15, wherein the RF signal is a GNSS signal and the multiple RF recording systems are GNSS recording systems.
